(19) United States
(12) Patent Application Publication
(10) Pub. No.: US 2001/0035079 A1
(43) Pub. Date: Nov. 1, 2001

(54) Multi-functional hand tool assembly with storage handle and multiple tool attachments

(76) Inventors: Eric S. Kesinger, Lakewood, CO (US); Donald A. Kesinger, Morrison, CO (US)

Correspondence Address: John R. Flanagan, FLANAGAN & FLANAGAN, P.O. Box 11300, Jackson Hole, WY, 83002, US

(21) Appl. No.: 09/801,279

(22) Filed: Mar. 7, 2001

Related U.S. Application Data
(60) Provisional application No. 60/187,785, filed on Mar. 8, 2000.

(51) Int. Cl. B25F 1/00

(52) U.S. Cl. 81/437

(57) ABSTRACT

A multi-functional hand tool assembly includes a handle with tool attachments. The handle has opposite ends with opposite holes extending therethrough. The tool attachments are removably, interchangeably and reversibly insertable into the handle ends and each has a middle section and end tool sections connected to and extending in opposite directions from opposite ends of the middle section. Each middle section is identical to one another and has a continuous exterior surface which matches a continuous interior end surface defining each hole in a handle end such that the middle sections can snugly fit through the hole in either handle end so as to mount the tool attachments in non-rotatable relationships with the handle ends such that the tool attachments will turn with turning of the handle.

This utility patent application claims the benefit of provisional application No. 60/187,785 filed Mar. 8, 2000.

### BACKGROUND OF THE INVENTION

1. Field of the Invention

The present invention generally relates to a multiple functional hand tools and, more particularly, is concerned with a multi-functional hand tool assembly with storage handle and multiple tool attachments.

2. Description of the Prior Art

Various hand tools are known in the prior art to perform a variety of functions. In particular, U.S. Pat. No. 2,476,762 to Petre et al and U.S. Pat. No. 3,114,401 to Johnson disclose a hand tool which includes a handle and a screwdriver shank with different opposite tip configurations reversibly receivable in a sleeve in the handle. Also, the Johnson patent and U.K. Pat. No. 403,769 to Hibbard disclose a four-way hand tool which includes two pairs of tool attachments each fitting one of the opposite ends of a handle of the tool. Each pair of tool attachments of the Johnson and Hibbard hand tools are a pair of reversible sockets of different sizes which fit into holes of different sizes in opposite ends of a handle. In addition, torque limiting screwdrivers and ratchet wrenches having various constructions are known in the prior art.

A problem exists, however, with prior art hand tools in that each hand tool has its own particular construction which includes a handle for gripping and manipulating the tool in performing its particular function. The handle typically is the largest part of the tool and thus takes up the most storage space. Service personnel who need to have a variety of hand tools with them must incur the added expense of multiple tools with multiple handles and of larger storage containers to provide the extra space for the multiple tools and their handles.

### SUMMARY OF THE INVENTION

The present invention overcomes the aforementioned drawbacks by providing a multi-functional hand tool assembly with a common storage handle and multiple tool attachments accommodated by the handle so as to obviate the aforementioned problems with prior art designs.

Accordingly, the present invention is directed to a multi-functional hand tool assembly which comprises: (a) an elongated handle having opposite ends and a pair of opposite holes each extending into one of the opposite ends of the handle, the opposite holes being defined by substantially identical non-circular continuous interior end surfaces formed in the opposite ends of the handle; and (b) a plurality of tool attachments being removably, interchangeably and reversibly insertable into the opposite ends of the handle, each of the tool attachments having a middle section and opposite end tool sections connected to and extending in opposite directions from the middle section, the middle sections being substantially identical to one another and each having a non-circular continuous exterior surface which matches the non-circular continuous interior end surface defining each of the holes in the opposite ends of the handle such that the middle section of each of the tool attachments is slightly smaller in cross-sectional size than each of the holes so that the middle section of each of the tool attachments can snugly fit through either of the holes in the opposite ends of the handle so as to mount the tool attachments in non-rotatable relationships with the opposite ends of the handle such that the tool attachments will turn with turning of the handle. The handle also has an interior storage chamber defined therein extending between the opposite ends thereof. Each of the opposite holes in one of the opposite ends of the handle leading into the storage chamber. The middle section of at least one of the tool attachments has first and second parts pivotally articulated to each other.

The present invention also is directed to a multifunctional hand tool assembly which comprises: (a) an elongated handle including a pair of handle segments each having a pair of opposite ends and a pair of opposite holes each extending into respective outer and inner ones of the opposite ends of each of the handle segments, the opposite holes being defined by continuous interior end surfaces formed in the opposite ends of the respective handle segment; (b) a plurality of tool attachments being removably insertable into the outer ones of the opposite ends of each of the handle segments, each of the tool attachments having a continuous exterior surface which matches the continuous interior end surface defining each of the holes in the outer ones of the opposite ends of each of the handle segments such that each of the tool attachments is slightly smaller in cross-sectional size than each of the holes in the outer ends of each of the handle segments so that each of the tool attachments can snugly fit through one of the holes so as to mount the tool attachments in non-rotatable relationships therewith such that the tool attachments will turn with turning of the handle; and (c) a central interconnector tool attachment having a pair of opposite ends, at least one of the opposite ends being adapted to removably interfit with one of the holes in the inner ends of the handle segments and thereby interconnect and retain the handle segments together.

The present invention further is directed to a hand tool assembly which comprises: (a) an elongated handle having a pair of opposite ends and a hole extending into at least one of the opposite ends of said handle; and (b) at least one tool attachment being removably insertable into the one hole at the one opposite end of the handle so that the tool attachment can snugly fit through the one hole so as to mount the tool attachment in non-rotatable relationship therewith such that the tool attachments will turn with turning of the handle; (c) the one tool attachment being a torque wrench attachment.

The present invention still further is directed to a hand tool assembly which comprises: (a) an elongated handle having a pair of opposite ends and a hole extending into at least one of the opposite ends of said handle; and (b) at least one tool attachment being removably insertable into the one hole at the one opposite end of the handle so that the tool attachment can snugly fit through the one hole so as to mount the tool attachment in non-rotatable relationship therewith such that the tool attachments will turn with turning of the handle; (c) the one tool attachment being a reversible ratchet wrench attachment.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is an exploded perspective view of a first embodiment of a multi-functional hand tool assembly of the present invention having a handle and a plurality of tool attachments removably and reversibly insertable into opposite ends of the handle.

FIG. 2 is a fragmentary perspective view of the handle of the tool assembly of FIG. 1 with one of the tool attachments inserted at one end of the handle.

FIG. 3 is a fragmentary side elevational view of the handle of the tool assembly of FIG. 1 but having an articulated tool attachment with both pivotal parts of the articulated tool attachment shown in axial alignment with the handle and with one another.

FIG. 4 is another fragmentary side elevational view of the handle similar to that of FIG. 3 but with one pivotal part of the articulated tool attachment shown in axial alignment with the handle and with the other pivotal part of the articulated tool attachment pivoted ninety degrees relative to the one pivotal part and the handle.

FIG. 5 is an exploded perspective view of a second embodiment of the hand tool assembly of the present invention similar overall to the first embodiment of the assembly shown in FIG. 1 except now having a handle comprised of two segments and an interconnector tool attachment adapted to removably interconnect and retain the two segments of the handle together.

FIG. 6 is a perspective view of a modified form of the interconnector tool attachment of FIG. 5.

FIG. 7 is an exploded side elevational view of a third embodiment of the hand tool assembly of the present invention similar overall to the first embodiment of the assembly shown in FIG. 5 except now having a handle comprised of two segments and either one of two tool attachments permanently press-fit into one of the handle segments and removably received by the other handle segment.

FIG. 8 is a side elevational view of a fourth embodiment of the handle tool assembly of the present invention similar overall to the first embodiment of the assembly shown in FIG. 1 except now one of the tool attachments for the handle is a torque wrench attachment.

FIG. 9 is a side elevational view of another handle being an alternative to the handle of FIG. 8.

FIG. 10 is a front elevational view of the alternative handle as seen along line 10-10 of FIG. 9.

FIG. 11 is an enlarged side elevational view of the torque wrench attachment of FIG. 8 showing the attachment removed from and without the handle.

FIG. 12 is a longitudinal sectional view of the torque wrench attachment taken along line 12-12 of FIG. 11.

FIG. 13 is a cross-sectional view of the torque wrench attachment taken along line 13-13 of FIG. 12.

FIG. 14 is an end plan view of the torque wrench attachment as seen along line 14-14 of FIG. 12.

FIG. 15 is an opposite end plan view of the torque wrench attachment as seen along line 15-15 of FIG. 12.

FIG. 16 is a side elevational view of a fifth embodiment of the hand tool assembly of the present invention similar overall to the fourth embodiment of the assembly shown in FIGS. 11 and 12 except now the tool attachment is a reversible ratchet wrench attachment.

FIG. 17 is an end plan view of the ratchet wrench attachment as seen along line 17-17 of FIG. 16.

FIG. 18 is a longitudinal sectional view of the ratchet wrench attachment taken along line 18-18 of FIG. 17.

FIG. 19 is an enlarged end plan view of the ratchet wrench attachment of FIG. 16 with an end cap thereof removed.

FIG. 20 is a longitudinal sectional view of an elongated housing of the ratchet wrench attachment taken along line 20-20 of FIG. 19.

FIG. 21 is an end plan view of the housing of the ratchet wrench attachment as seen along line 21-21 of FIG. 20.

FIG. 22 is an opposite end plan view of the housing of the ratchet wrench attachment as seen along line 22-22 of FIG. 20.

FIG. 23 is an enlarged side elevational view of a ratchet shaft of the ratchet wrench attachment of FIG. 17.

FIG. 24 is an end plan view of a ratchet-defining end of the shaft as seen along line 24-24 of FIG. 23.

FIG. 25 is a side elevational view of a base portion of the ratchet wrench attachment of FIG. 16.

FIG. 26 is another side elevational view of the base portion as seen along line 26-26 of FIG. 25.

FIG. 27 is an end plan view of the base portion as seen along line 27-27 of FIG. 25.

FIG. 28 is a longitudinal sectional view of the end cap of the ratchet wrench attachment as seen along line 28-28 of FIG. 29.

FIG. 29 is an end plan view of the end cap as seen along line 29-29 of FIG. 28.

FIG. 30 is an enlarged elevational view of a double pawl of the ratchet wrench attachment of FIG. 18.

FIG. 31 is an end plan view of the double pawl as seen along line 31-31 of FIG. 30.

### DETAILED DESCRIPTION OF THE INVENTION

Referring to the drawings and particularly to FIGS. 1 to 4, there is illustrated a multi-functional hand tool assembly, generally designated 10, of the present invention. The hand tool assembly 10 basically includes an elongated handle 12, made of a suitable material such as a metal or plastic, and a plurality of tool attachments 14, made of a suitable material such as a metal, being interchangeably, removably and reversibly insertable in the opposite ends 12A of the handle 12. The handle 12 has a generally cylindrical configuration and can define an interior storage chamber 16 extending between the opposite ends 12A. The handle 12 also has a pair of opposite holes 18 extending through the opposite ends 12A of said handle. Where the handle 12 has the interior storage chamber 16, the opposite holes 18 can lead into the storage chamber 16. Preferably, the storage chamber 16 does not extend uninterrupted between the opposite ends 12A of the handle 12. Instead, the storage chamber 16 is separated into two back-to-back compartments by a transverse wall 12C extending across the chamber 16 at the middle of the handle 12. The holes 18 are defined by substantially identical, noncircular, and preferably hexagonal-shaped, continuous interior end surfaces 12B formed at the opposite ends 12A of the handle 12. Each interior end surface 12B has a continuous detent in the form of a groove 20 formed therein. The interior end surface 12B and groove 20 at each end 12A of the handle 12 extend symmetrically about a central longitudinal axis A of the handle 12. The handle 12 also has an external annular hand grip 22 for gripping by a user to turn the handle 12 about its central longitudinal axis A.

Each tool attachment 14 has a middle section 24 and opposite end tool sections 26 connected to and merging from the opposite ends of the middle section 24 and extending in opposite directions therefrom. The middle sections 24 of the tool attachments 14 have substantially identical non-circular, and preferably hexagonal-shaped, continuous exterior surfaces 24A which match the non-circular continuous interior end surfaces 12B defining the holes 18 in the opposite ends 12A of the handle 12 such that the middle sections 24 of the tool attachments 14 are slightly smaller in cross-sectional size than the holes 18 so that the middle sections 24 can snugly fit through either of the holes 18.

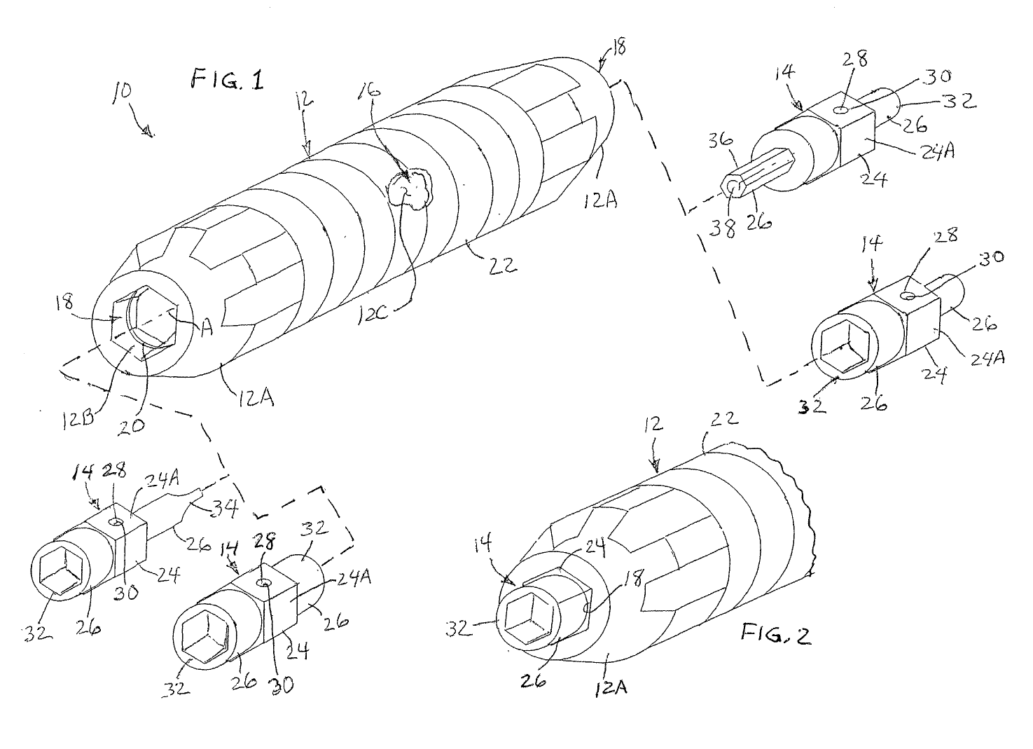

Each middle section 24 has a detent in the form of a ball 28 of a shape complementary to that of the groove 20 and yieldably seated in a recess 30 in the exterior surface 24A thereon such that the ball 28 is spring-biased to protrude beyond the exterior surface 24A but is retractable into the recess 30 upon application of an external force on the ball 28. When the middle section 24 of the tool attachment 14 is inserted through one of the holes 18, the ball 28 will snap fit in the groove 20 so as to releasably retain the tool attachment 14 mounted in the respective end 12A of the handle 12 in a non-rotatable fixed relationship with the handle 12, as seen in FIG. 2, such that the tool attachment 14 will turn with the turning of the handle 12 by a user about the longitudinal axis A. The spring bias force of the ball 28 can be easily overcome and the tool attachment 14 removed from the respective end 12A of the handle 12 by gripping the exposed end tool section 26 and applying a small amount of axially-directed pulling force thereon.

The opposite end tool sections 26 of the tool attachments 14 of FIG. 1 can take various forms. For instance as shown in FIG. 1, the various tool sections 26 can be wrench sockets 32 of different sizes, such as ½, ⅜, 7/16 and ¼ inch, a screwdriver straight blade 34 or a hex wrench 36 with a security pin hole 38.

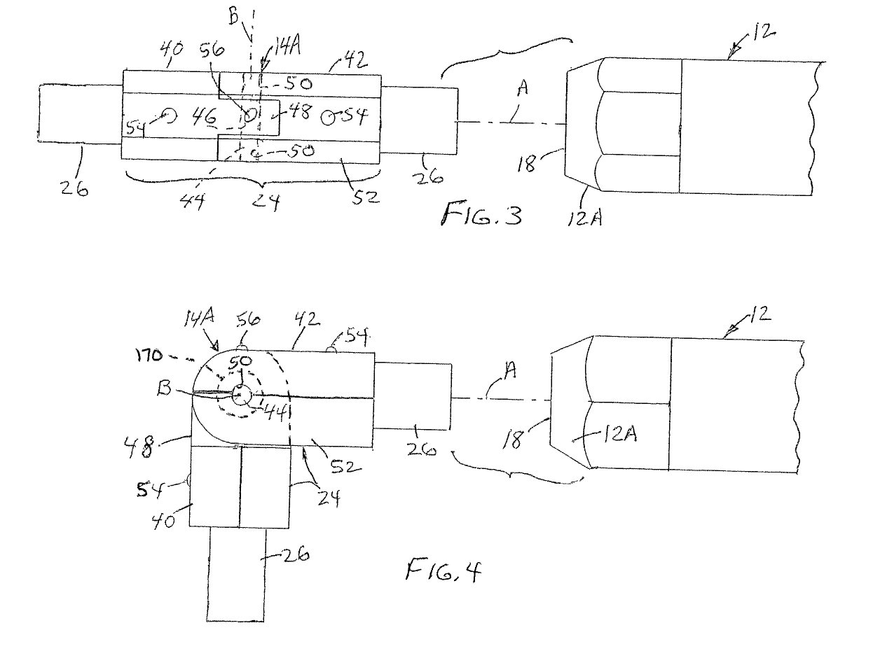

The tool attachment 14A of FIGS. 3 and 4 also has a middle section 24 and a pair of opposite end tool sections 26. However, here, the middle section 24 of the tool attachment 14A is an articulated component being comprised of two parts 40, 42 pivotally connected to each other by a pin 44 extending through a hole 46 in a tongue end structure 48 on the one part 40 and a pair of holes 50 in a bifurcated end structure 52 on the other part 42. The tongue end structure 48 is received within the bifurcated end structure 52 and retained therein by the pin 44 but pivotally movable relative thereto about an axis B defined by the pin 44 that extends in a transverse relationship to the longitudinal axis A of the handle 12. The opposite end tool sections 26 are sockets of different sizes. The tool attachment 14A when inserted up to either of its two articulated parts 40, 42 into the hole 18 at one of the ends 12A of the handle 12 can function as an articulated or pivotal tool element if either of a pair of outer two detents in the form of spring-biased balls 54 are snap fitted in the groove (not shown) in the hole 18 at the handle end 12A or can function as a straight tool element if a middle detent in the form of a spring-biased ball 56 on the tongue end structure 48 is snap fitted in the groove.

Referring to FIGS. 5 and 6, there is shown a second embodiment of the hand tool assembly of the present invention, generally designated 10A. The hand tool assembly 10A has a construction generally similar overall to that of the hand tool assembly 10 of FIG. 1 except for the following differences. In the second embodiment of the assembly 10A, the handle 12 includes two annular segments 58 which can be substantially identical to one another, only single socketed tool attachments 14B are provided for attaching to the outer ends 58A of the annular handle segments 58, and a double detented central interconnector tool attachment 60 is used to removably interconnect and retain the handle segments 58 together. The left tool attachment 14B is a special socket 62 having a non-circular extension 62A which presses into a round hole 64 in the outer end 58A of the left handle segment 58. Alternatively, the extension 62A could be made round with an annular knurled portion (not shown) and fit into the round hole 64. The right tool attachment 14B has a standard socket configuration. The central interconnector tool attachment 60 has a middle section 66 which slip fits with the inner ends 58B of the handle segments 58. The middle section 66 has two spaced apart spring-biased detent balls 68 which may removably snap fit into complementary detent grooves (not shown) in the inner ends 58B of the handle segments 58. As seen in FIG. 5, the central interconnector tool attachment 60 also has tool elements, such as a hex socket security head 70 and a straight screwdriver bit 72 attached to and extending axially from the opposite ends of the middle section 66. In a modified central interconnector tool attachment 60A as shown in FIG. 6, a punchdown tool element 74 is provided instead of the screwdriver bit 72 as shown in FIG. 5.

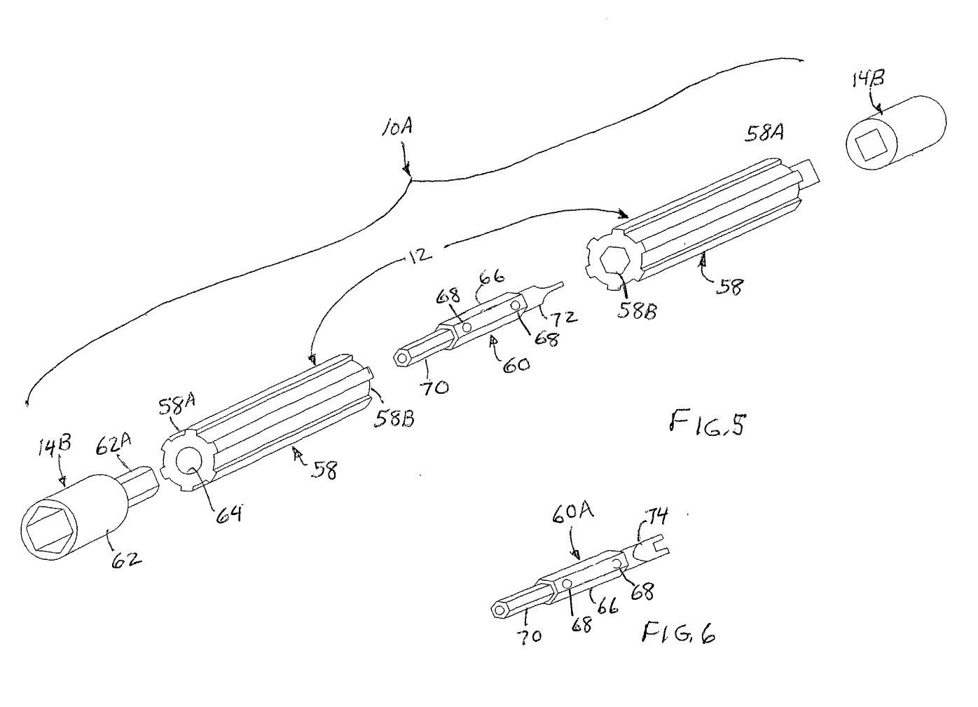

Referring to FIG. 7, there is shown a third embodiment of the hand tool assembly of the present invention, generally designated 10C. The hand tool assembly 10C has a construction generally similar overall to that of the hand tool assembly 10A of FIG. 1, except for the following differences. In the third embodiment of the assembly 10B, the handle 12 includes two annular segments 76 which can be substantially identical to one another, either one of two alternative designs of additional tool attachments 78, 80 which is disposed between and interconnects the two handle segments 76, and a rigid annular insert sleeve 82 which is press-fitted into a central bore 84 of the left one of the handle segments 76 from the outer end 76A thereof. The sleeve 82 defines the opening 18 and the detent groove 20 at the outer end 76A of the left handle segment 76 for removably and interchangeably receiving therein the middle section 24 of a tool attachment 14 and the detent ball 28 thereon which snap fits into the groove 20. The two alternative designs of tool attachments 78, 80 have right end portions 78A, 80A of non-circular cross-sectional configuration adapted to be substantially permanently press-fitted into the central bore 84 of a right one of the handle segments 76 from the inner end 76B thereof. The tool attachments 78, 80 also have respective left end portions 78B, 80B defined as a given socket end section adapted to be removably received in the central bore 84 of the left one of the handle segments 76 from the inner end 76B thereof. The tool attachments 78, 80 further have respective middle portions 78C, 80C disposed between and integrally connecting the right and left end portions 76A, 80A and 76B, 80B with one another. The middle portions 78C, 80C have detent balls 86 thereon which snap fit into the retaining groove 88 in the bore 84 of the left one of the handle segments 76 allowing the tool attachments 78, 80 to be removed therefrom. Thus, the hand tool assembly 10B provides an additional, tool attachment 78 or 80 permanently mounted to the inner end 76B of one of the handle segments 76 which is stored within the other of the handle segments 76 when not in use and functions to retain the handle segments 76 together as the single handle 12. Also, the hand tool assembly 10B has a tool attachment 90 substantially permanently press-fitted into the central bore 84 of the right one of the handle segments 76 from the outer end 76A thereof.

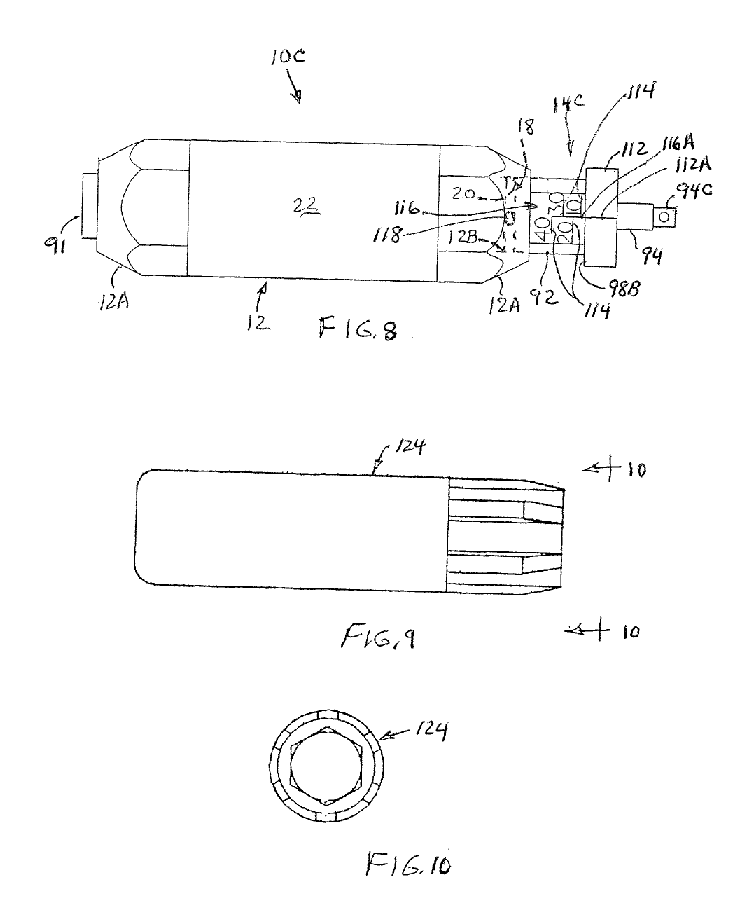

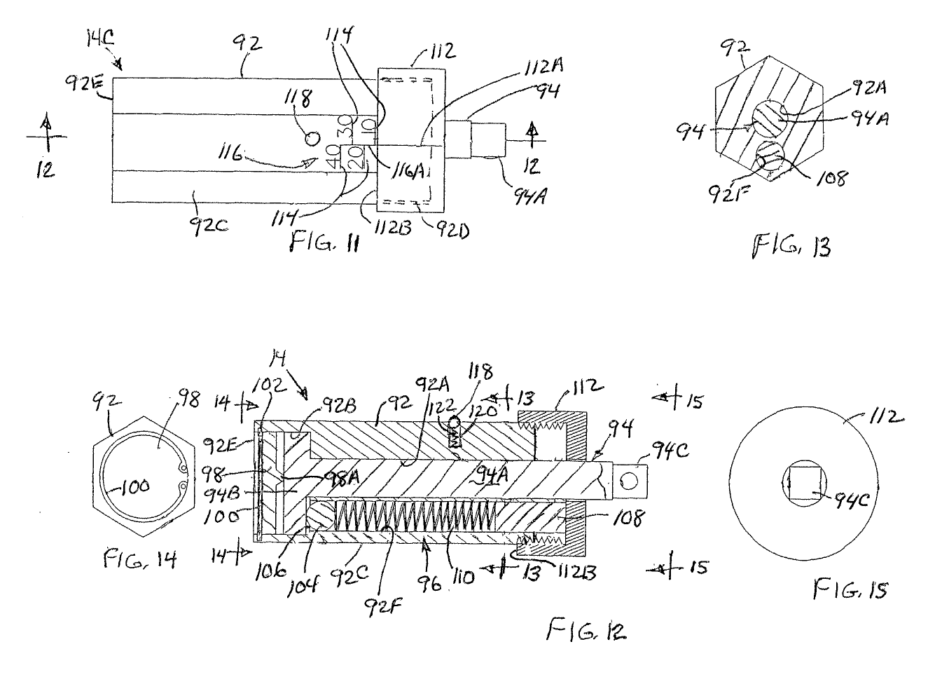

Referring to FIGS. 8 to 15, there is shown a fourth embodiment of the handle tool assembly of the present invention, generally designated 10C. The hand tool assembly 10C has a construction generally similar overall to that of the hand tool assembly 10A of FIG. 1, except now one of the tool attachments 14C for the handle 12 is a torque wrench attachment fitted into the hole 18 at the one end 12A of the handle 12 (shown in FIG. 1) and an end cap 91 is removably fitted to the other end 12A of the handle 12 so as to close the interior storage chamber 16 in the handle 12. The torque wrench attachment 14C basically includes an elongated main housing or body 92, a drive shaft 94 and a torque adjustment mechanism 96. The main body 92 has a central longitudinal passage 92A, an end cavity 92B merging with the central passage 92A, and a non-circular, and preferably hexagonal-shaped, exterior surface 92C which matches the interior end surface 12B of the handle 12 at the one end 12A thereof allowing the main body 92 to be removably inserted into the hole 18 at the one end 12A of the handle 12, the same as shown in FIG. 1 with respect to the other tool attachments 14. Alternatively, the main body 92 can have a short stub shaft press-fitted into the hole 18 at the one end 12A of the handle 12. The drive shaft 94 has a main shaft portion 94A disposed through the central passage 92A of the main body 92 and an end flange portion 94B disposed in the end cavity 92B of the main body 92. The main shaft portion 94A of the drive shaft 94 at its free end 94C opposite from the end flange portion 94B extends beyond an externally threaded end 92D of the main body 92. An end plate 98 is received in the end cavity 92B of the main body 92 outwardly of the end flange portion 94B of the drive shaft 94 and has a protuberance 98A which is held against the end flange portion 94B by a split retaining ring 100 seated in an interior groove 102 at the opposite open end 92E of the main body 92. With only the protuberance 98A contacting the end flange portion 96B of the drive shaft 94, friction is reduced when the drive shaft 94 must slip.

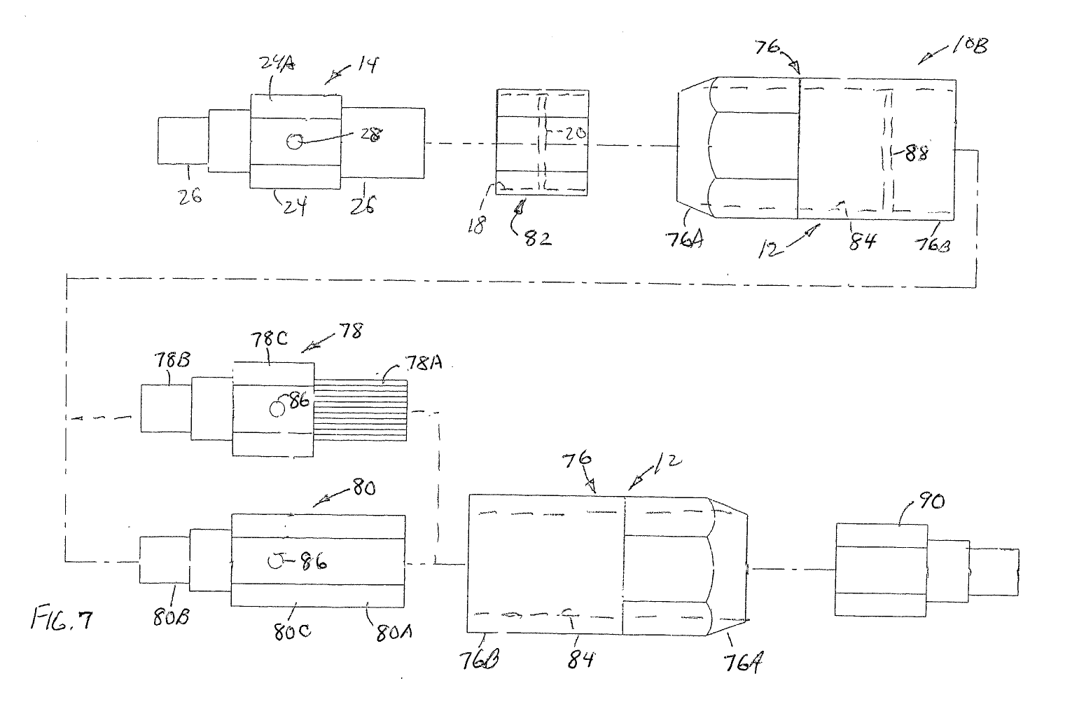

The torque adjustment mechanism 96 of the torque wrench attachment 14C is disposed in another passage 92F defined parallel to but radially outwardly from the central passage 92A of the main body 92. The offset passage 92F extends from the threaded end 92D to the end cavity 92B of the main body 92. The torque adjustment mechanism 96 includes a ball 104 disposed adjacent to and in contact with a notch 106 defined in the end flange portion 94B, a pin 108 slidably disposed in the offset passage 92F adjacent to the threaded end 92D of the main body 92 and a coil spring 110 disposed in the offset passage 92F between the ball 104 and pin 108. An adjusting nut 112 is threaded onto the externally threaded end 92D of the main body 92 and can be turned by a user clockwise or counterclockwise to thread onto or unthread from the body 92 so as to increase or decrease the torque in accordance with the inch-lbs gradations 114 of the torque scale 116 on the exterior surface 92C of the main body 92. Adjustment of the torque is made by turning the adjusting nut 112 relative to the main body 92 to place a longitudinal mark 116A on the adjusting nut 112 in alignment with a central longitudinal mark 116B on the main body 92 and an edge 112B of the adjusting nut 112 in alignment with a selected one of the gradations 114. By way of example only, one complete rotation or turn of the adjusting nut 112 advances the torque by 10 inch pounds. The free end 94C of the drive shaft 94 has a non-circular shape allowing it to removably receive a socket. The above-described torque adjustment mechanism 96 via its ball 104 engages the notch 106 in the end flange portion 94B of the drive shaft 94 with the set amount of spring force so as to cause the drive shaft 94 to rotate with the main body 92 and the handle 12 holding the body 92 until the torque required to be applied to the handle 12 to turn a socket (not shown) on the free end 94C of the drive shaft 94, that is engaged with an external fastener being tightened, exceeds the compression force of the coil spring 110 applied via the ball 104 to the drive shaft flange portion 94B of the drive shaft 94. Once the force is exceeded, the drive shaft 94 will slip relative to the torque adjustment mechanism 96 and the main body 92 and handle 12 being turned by a user. The main body 92 of the attachment 14C also includes a detent ball 118 disposed in a recess 120 and biased by a spring 122 to protrude beyond the exterior surface 92C of the main body 92 but is retractable into the recess 120 upon application of an external force on the ball 118 such as occurs when the attachment 14C is inserted into opening 18 in the end 12A of the handle 12 as seen in FIG. 10. The ball 118 will snap fit into the detent groove 20 of the handle 12. FIGS. 9 and 10 illustrate an alternative handle 124 which can be used. Also, by replacing the pin 108 with a set screw a fixed torque is provided and can be set at the factory.

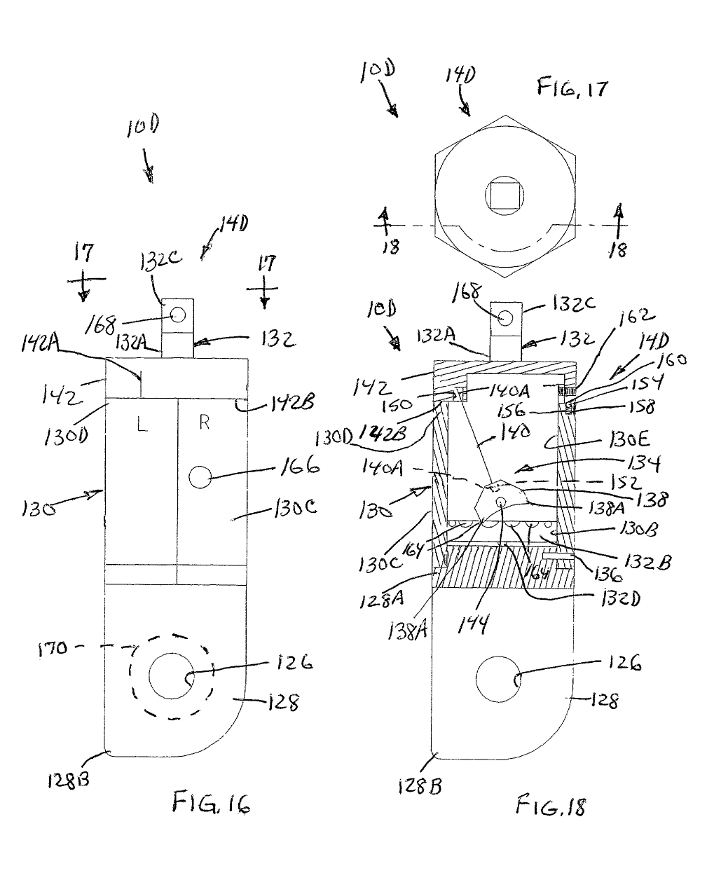

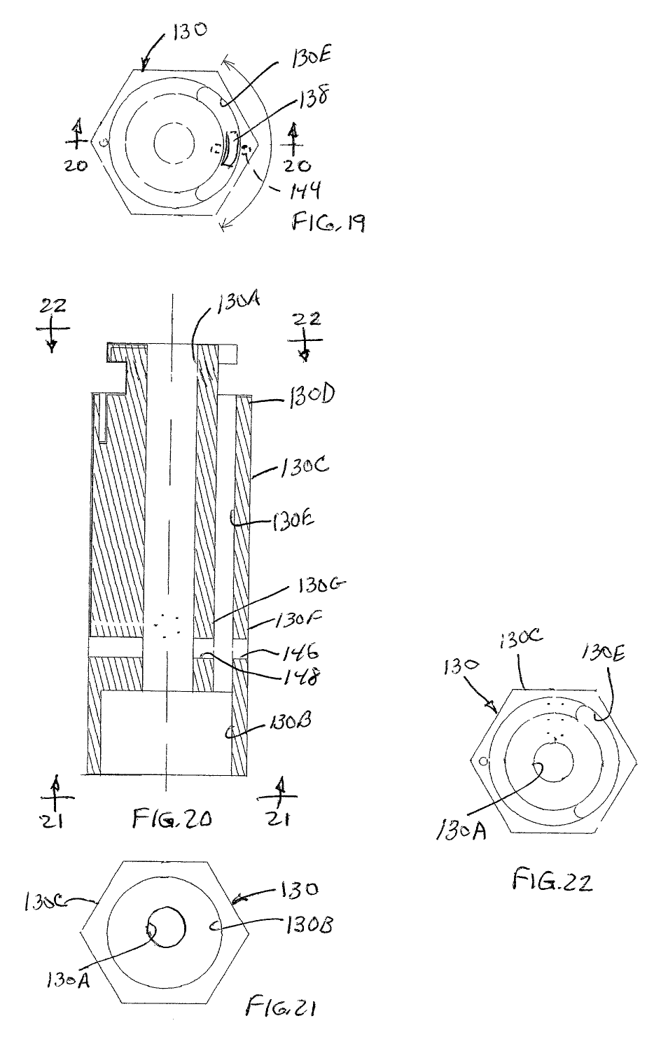

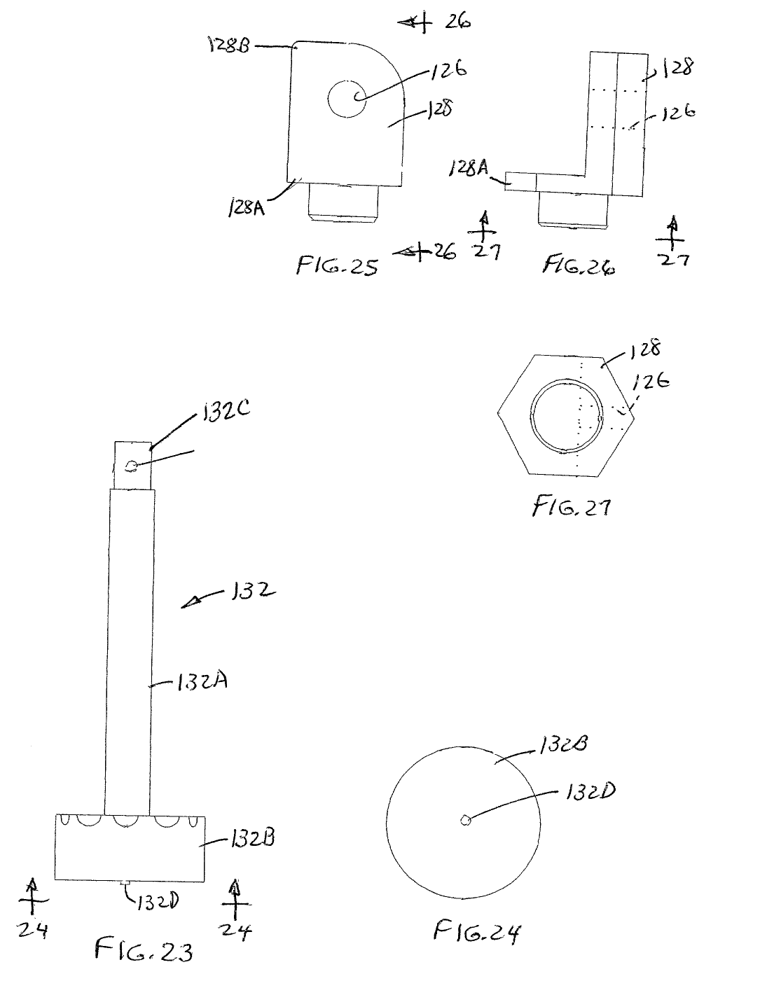

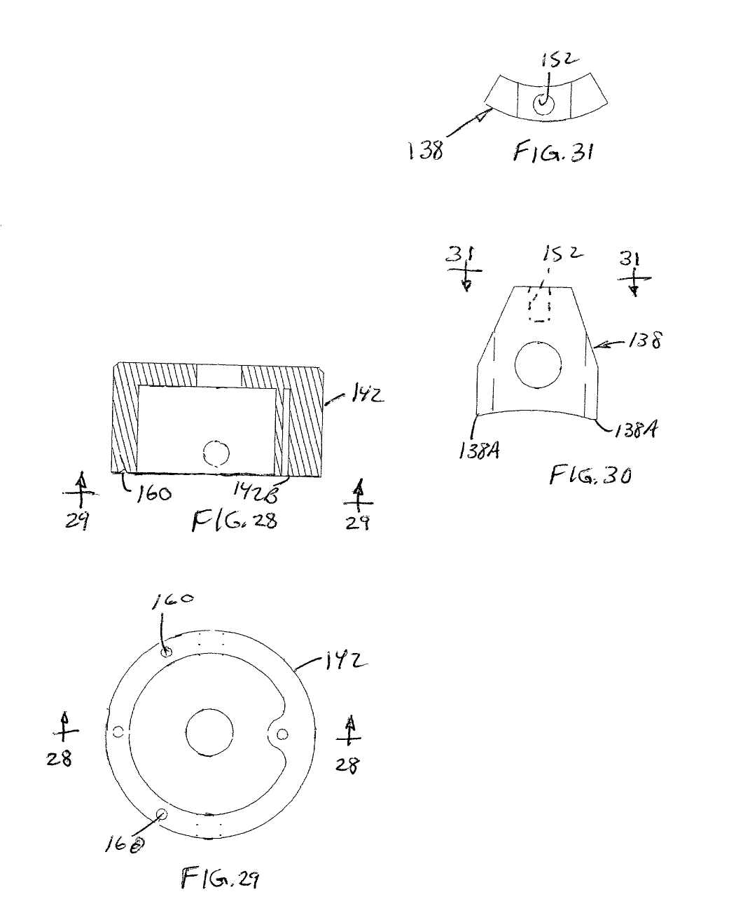

Referring to FIGS. 16 to 31, there is shown a fifth embodiment of the handle tool assembly of the present invention, generally designated 10D. The hand tool assembly 10D has a construction generally similar overall to that of the hand tool assembly 10C with the torque wrench attachment 14C of FIGS. 11 and 12, except now the tool attachment for the handle 12 is a reversible ratchet wrench attachment 14D. The rachet wrench attachment 14D is adapted to have the form of the articulated tool attachment 14A of FIGS. 3 and 4. The one part 40 of the articulated tool attachment 14A of FIGS. 3 and 4 is now in the form of the ratchet wrench attachment 14D of FIGS. 16 to 18 which is pivotally hinged through a hole 126 in a base portion 128 of the ratchet wrench attachment 14D to the same other part 42 of the articulated tool attachment 14A of FIGS. 3 and 4 by the pin 44. The other part 42, in turn, fits into the one end 12A of the handle 12 of FIGS. 1 or 8.

The reversible ratchet wrench attachment 14D basically includes an elongated main housing or body 130, a drive shaft 132 and a reversible ratchet mechanism 134. The main body 130 has a central longitudinal passage 130A, an end cavity 130B merging with the central passage 130A, and a non-circular, and preferably hexagonal-shaped, exterior surface 130C which matches the interior end surface 12B of the handle 12 at the one end 12A thereof allowing the main body 130 to be removably inserted into the hole 18 at the one end 12A of the handle 12, the same as shown in FIG. 1 with respect to the other tool attachments 14. The drive shaft 132 has a main shaft portion 132A disposed through the central passage 130A of the main body 130 and an end flange portion 132B disposed in the end cavity 130B of the main body 130. The main shaft portion 132A of the drive shaft 132 at its free end 132C opposite from the end flange portion 132B extends beyond an adjacent end 130D of the main body 130. An end 128A of the base portion 128 is received in the end cavity 130B of the main body 130 outwardly of the end flange portion 132B of the drive shaft 132 and is secured therein by a pin 136 extending through the main body 130 into the end cavity 130B thereof. The end flange portion 132B of the drive shaft 132 has a protuberance 132D which contacts the end 128A of the base portion 128 of the ratchet wrench attachment 14D. With only the protuberance 132D of the end flange portion 132B of the drive shaft 132 contacting the end 128A of the base portion 128 of the ratchet wrench attachment 14D, friction is reduced between the drive shaft 132 and the base portion 128.

The reversible ratchet mechanism 134 of the ratchet wrench attachment 14D is disposed in another passage 130E defined parallel to but radially outwardly from the central passage 130A of the main body 130. The offset passage 130E which is arcuate-shaped in cross-section extends from the end 130D to the end cavity 130B of the main body 130. The reversible ratchet mechanism 134 includes a double pawl 138, a spring 140 and an adjusting end cap 142. The double pawl 138 is pivotally mounted by a pin 144 inserted through holes 146, 148 formed in adjacent outer and inner wall portions 130F, 130G of the main body 130. The end cap 142 is rotatably mounted over the end 130D of the main body 130 and can be turned by a user in either clockwise or counterclockwise directions relative to the body 130. The spring 140 is in the form of spring wire extending between and having opposite ends 140A secured in recesses 150, 152 formed respectively in the end cap 142 and double pawl 138 at a location spaced above the pivot mounting pin 144. The spring 140 loads or biases the double pawl 138 in either direction depending on the rotated position of the end cap 142. As the end cap 142 is rotated from left to right, the rotation of the drive shaft 132 is switched from left to right. An index mark 142A on the cap 142 indicates the cap position and marks L and R on the main body 130 show the direction of rotation. The loading or biasing of the double pawl 138 by the spring 140 provides a power stroke in one direction and a ratcheting return in the opposite direction. The end cap 142 is held in its rotated position by a detent ball 154 and a spring 156 thereunder in a recess 158 defined in the end 130D of the main body 130 which spring 156 forces the detent ball 154 against one of two matching indentations 160 formed in the lower lip 142B of the end cap 142. The end cap 142 is held on the end 130D of the main body 130 by a set screw 162 or could be snapped on permanently.

The double pawl 138 has a right and left teeth 138A defined at opposite edges thereof in opposite directions from the pivot mounting pin 144. The right and left teeth 138A are disposed adjacent to and alternately capable of engaging selected ones of a row of notches 164 defined in the end flange portion 132B of the drive shaft 132. The double pawl 138 has an arcuate cross-sectional configuration which conforms to the arcuate cross-sectional configuration of the offset passage 130E across which the double pawl 138 is pivotally mounted by the pin 144.

The main body 130 also has a spring loaded ball detent 166 protruding from the external surface 130C thereof which holds the ratchet wrench attachment 14D inside the hole 18 in the handle 12 engaging a complementary detent therein. The base portion 128 is restricted from rotating in one direction relative to the part 42 of the articulated tool attachment 14D by the presence of the square corner 128B thereon. When the attachment 14D is in a half exposed position extending from the handle 12, the main body 130 (and ratchet mechanism 134 thereon) being supported on the base portion 128 can be rotated ninety degrees relative to the part 42 about the pin 44 through the hole 126 in the base portion 128 so as to provide leverage to the user. The free end 132C of the drive shaft 132 has a ball detent 168 thereon which can hold a socket or other tool bit in place thereon.

In the articulated embodiments of FIGS. 3, 4 and 16, 18, there is a spring washer 170 incorporated at the hinge point to maintain the position of the articulated parts once they have been pivoted relative to one another.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

We claim:

1. A multi-functional hand tool assembly, comprising:
(a) an elongated handle having opposite ends and a pair of opposite holes each extending into one of said opposite ends of said handle, said opposite holes being defined by substantially identical non-circular continuous interior end surfaces formed in said opposite ends of said handle; and
(b) a plurality of tool attachments being removably, interchangeably and reversibly insertable into said opposite ends of said handle, each of said tool attachments having a middle section and opposite end tool sections connected to and extending in opposite directions from opposite ends of said middle section, said middle section of each of said tool attachments being substantially identical with one another and having a non-circular continuous exterior surface which matches said non-circular continuous interior end surface defining each of said holes in said opposite ends of said handle such that said middle section of each of said tool attachments is slightly smaller in cross-sectional size than each of said holes so that said middle section of each of said tool attachments can snugly fit through said holes in either of said opposite ends of said handle so as to mount said tool attachments in non-rotatable relationships with said opposite ends of said handle such that said tool attachments will turn with turning of said handle.

2. The assembly of claim 1 wherein said handle has a generally cylindrical configuration.

3. The assembly of claim 1 wherein said handle has an interior storage chamber defined therein extending between said opposite ends thereof, each of said opposite holes in said one of said opposite ends of said handle leading into said storage chamber.

4. The assembly of claim 3 wherein said storage chamber is separated into two back-to-back compartments by a wall extending across said storage chamber at a location intermediately between said opposite ends of said handle.

5. The assembly of claim 1 wherein each of said interior end surfaces has a first detent thereon.

6. The assembly of claim 5 wherein said middle section of each of said tool attachments has a second detent thereon complementary to said first detent on said interior end surface on each of said opposite ends of said handle such that upon insertion of each of said middle sections of said tool attachments through either of said holes in said opposite ends of said handle said first and second detents will mate with one another so as to releasably retain said tool attachments mounted in said non-rotatable fixed relationships with said opposite ends of said handle.

7. The assembly of claim 1 wherein said middle section of at least one of said plurality of tool attachments has first and second parts pivotally articulated to each other.

8. The assembly of claim 7 wherein said opposite end tool sections of said at least one tool attachment having said articulated middle section are sockets of different sizes.

9. The assembly of claim 7 wherein said at least one tool attachment is insertable up to either of said two articulated parts thereof into either of said holes in said opposite ends of said handle such that said one tool attachment can function as an articulated tool element.

10. The assembly of claim 7 wherein said at least one tool attachment is insertable past either of said two articulated parts thereof into either of said holes in said opposite ends of said handle such that said one tool attachment can function as a straight tool element.

11. A multi-functional hand tool assembly, comprising:
(a) an elongated handle including a pair of handle segments each having a pair of opposite ends and a pair of opposite holes each extending into respective outer and inner ones of said opposite ends of each of said handle segments, said opposite holes being defined by continuous interior end surfaces formed in said opposite ends of said handle segment;
(b) a plurality of tool attachments being removably insertable into said outer ones of said opposite ends of each of said handle segments, each of said tool attachments having a continuous exterior surface which matches said continuous interior end surface defining each of said holes in said outer ones of said opposite ends of each of said handle segments such that each of said tool attachments is slightly smaller in cross-sectional size than each of said holes in said outer ends of each of said handle segments so that each of said tool attachments can snugly fit through one of said holes so as to mount said tool attachments in non-rotatable relationships therewith such that said tool attachments will turn with turning of said handle; and
(c) a central interconnector tool attachment having a pair of opposite ends, at least one of said opposite ends being adapted to removably interfit with one of said holes in said inner ends of said handle segments and thereby interconnect and retain said handle segments together.

12. The assembly of claim 11 wherein both of said opposite ends being adapted to removably interfit with respective ones of said holes in said inner ends of said handle segments.

13. The assembly of claim 11 wherein said central interconnector tool attachment has a middle section which slip fits with said inner ends of said handle segments.

14. The assembly of claim 13 wherein middle section has two spaced apart first detents.

15. The assembly of claim 14 wherein said inner ends of said handle segments have second detents complementary to said first detents and which can removably mate with said first detents in said inner ends of said handle segments so as to releasably retain said central interconnector tool attachment mounted in said non-rotatable fixed relationships with said inner ends of said handle segments.

16. A hand tool assembly, comprising:
(a) an elongated handle having a pair of opposite ends and a hole extending into at least one of said opposite ends of said handle; and
(b) at least one tool attachment being removably insertable into said hole in said one of said opposite ends of said handle so that said tool attachment can snugly fit in said one hole so as to mount said tool attachment in a non-rotatable relationship therewith such that said one tool attachment will turn with turning of said handle;
(c) said one tool attachment being a torque wrench attachment.

17. The assembly of claim 16 wherein said torque wrench attachment includes an elongated main body having opposite ends and a central longitudinal passage extending between said opposite ends, an offset passage extending between said opposite ends substantially parallel to but offset radially outwardly from said central passage, and an end cavity merging with said central and offset passages at one of said opposite ends of said main body.

18. The assembly of claim 17 wherein said main body also includes a non-circular exterior surface on said main body which matches an interior end surface of said one end of said handle defining said hole therein so as to allow said main body to be inserted into said hole in said one end of said handle and form a non-rotational relationship therewith.

19. The assembly of claim 18 wherein said main body also includes a detent on said exterior surface of said main body for mating a complementary detent on said interior end surface of said one end of said handle when said attachment is inserted into said hole in said one end of said handle.

20. The assembly of claim 17 wherein said torque wrench attachment further includes a drive shaft having a main shaft portion disposed through said central passage of said main body and an end flange portion attached at one end of said main shaft portion and disposed in said end cavity of said main body, said main shaft portion also having a free end opposite from said end flange portion which extends beyond the other of said opposite ends of said main body and has a noncircular shape allowing said free end to removably receive a tool bit.

21. The assembly of claim 20 wherein said torque wrench attachment further includes means disposed in said end cavity of said main body outwardly of said end flange portion of said drive shaft for applying contact against an outer side of said end flange portion of said drive shaft.

22. The assembly of claim 20 wherein said torque wrench attachment further includes a torque applying mechanism disposed in said offset passage and operable for applying a given force on said end flange portion of said drive shaft that will set a maximum torque and hold said drive shaft in non-rotational relationship with said main body and said handle holding said main body so long as said maximum torque is not exceed by the torque applied to said main body by a user.

23. The assembly of claim 22 wherein said torque applying mechanism includes:
a notch defined in said end flange portion of said drive shaft;
a ball disposed adjacent to and in contact with said notch in said end flange portion;
a pin slidably disposed in said offset passage and extending from said other end of said main body;
a spring disposed in said offset passage between said ball and said pin; and
an adjusting nut threaded onto said other end of said main body such that by turning said adjusting nut clockwise or counterclockwise so as to thread onto or unthread from said main body said given force holding said drive shaft in a non-rotational relationship with said main body can be increased or decreased and thereby adjust said maximum torque that can be applied to said main body without causing said drive shaft to rotate relative to said main body such as occurs when the torque applied by a user exceeds said maximum torque causing said drive shaft to slip and rotate relative to said main body and thus relative to said handle holding said main body.

24. A hand tool assembly, comprising:
(a) an elongated handle having a pair of opposite ends and a hole extending into at least one of said opposite ends of said handle; and
(b) at least one tool attachment being removably insertable into said hole in said one of said opposite ends of said handle so that said tool attachment can snugly fit into said one hole so as to mount said tool attachment in a non-rotatable relationship therewith such that said one tool attachment will turn with turning of said handle;
(c) said one tool attachment being a reversible ratchet wrench attachment.

25. The assembly of claim 24 wherein said reversible ratchet wrench attachment includes an elongated main body having opposite ends and a central longitudinal passage extending between said opposite ends, an offset passage extending between said opposite ends substantially parallel to but offset radially outwardly from said central passage, and an end cavity merging with said central and offset passages at one of said opposite ends of said main body.

26. The assembly of claim 25 wherein said main body also includes a non-circular exterior surface on said main body which matches an interior end surface of said one end of said handle defining said hole therein so as to allow said main body to be inserted into said hole in said one end of said handle and form a non-rotational relationship therewith.

27. The assembly of claim 26 wherein said main body also includes a detent on said exterior surface of said main body for mating a complementary detent on said interior end surface of said one end of said handle when said attachment is inserted into said hole in said one end of said handle.

28. The assembly of claim 25 wherein said torque wrench attachment further includes a drive shaft having a main shaft portion disposed through said central passage of said main body and an end flange portion attached at one end of said main shaft portion and disposed in said end cavity of said main body, said main shaft portion also having a free end opposite from said end flange portion which extends beyond the other of said opposite ends of said main body and has a noncircular shape allowing said free end to removably receive a socket.

29. The assembly of claim 28 wherein said torque wrench attachment further includes means disposed in said end cavity of said main body outwardly of said end flange portion of said drive shaft for applying contact against an outer side of said end flange portion of said drive shaft.

30. The assembly of claim 25 wherein said ratchet wrench attachment further includes a reversible ratchet mechanism disposed in said offset passage and having double pawl pivotally mounted by a pin extending across said offset passage.

31. The assembly of claim 30 wherein said offset passage is arcuate-shaped cross-section and said double pawl is disposed in said offset passage and is arcuate-shaped in cross-section so as to accommodate positioning of said double pawl in said offset passage.

32. The assembly of claim 30 wherein said ratchet wrench attachment further includes:
an adjusting end cap rotatably mounted over an end of said main body and turnable by a user in either clockwise or counterclockwise directions relative to said main body; and
a spring extending between and having opposite ends secured in recesses formed respectively in said end cap and said double pawl and biasing said double pawl in either direction depending on the rotated position of said end cap relative to said main body and pawl such that as said end cap is rotated from left to right, said rotation of said drive shaft is switched from left to right and said biasing of said double pawl by said spring provides a power stroke in one direction and a ratcheting return in the opposite direction.

33. The assembly of claim 32 wherein said double pawl has right and left teeth defined at opposite edges of said double pawl such that said right and left teeth are disposed adjacent to and alternately capable of engaging selected ones of a row of notches defined in the end flange portion of said drive shaft.
